(19) United States
(12) Patent Application Publication
(10) Pub. No.: US 2001/0034735 A1
(43) Pub. Date: Oct. 25, 2001

(54) System and method for supporting user registration, and recording medium which records the same

(76) Inventor: Akihiro Sugiyama, Tokyo (JP)

Correspondence Address: SUGHRUE, MION, ZINN, MACPEAK & SEAS, 2100 Pennsylvania Avenue, N.W., Washington, DC, 20037, US

(21) Appl. No.: 09/838,342

(22) Filed: Apr. 20, 2001

(30) Foreign Application Priority Data
Apr. 21, 2000 (JP) 120476/2000

(51) Int. Cl. G06F 17/30; G06F 15/16; G06F 17/60

(52) U.S. Cl. 707/104.1; 705/1; 707/10; 709/219

(57) ABSTRACT

A user registration supporting system comprises a user-information database, a user-information providing section, and a to-be-registered information generating section, and supports a user, whose uses a multi-component product including a plurality of products provided by a plurality of companies, in applying for user registration for the products. The user-information database stores user information including a plurality of data items regarding the user. The user-information providing section provides the user-information database with the user information. The to-be-registered information generating section extracts a data item required by each of the companies for the user registration from the user information stored in the user-information database, and generates to-be-registered information which is used by each of the companies for the user registration. This user registration supporting system can generate the to-be-registered information for the plurality of companies at once, based on the user information.

### BACKGROUND OF THE INVENTION

1. Field of the Invention

The present invention relates to a system and method for supporting user registration, and a recording medium which records the same, and more particularly to a system and method for supporting users in applying for user registration for products used by the users, and a recording medium which records the same.

2. Description of the Related Art

For example, computers, in which various kinds of software are installed, include a plurality of products such as those software or various kinds of hardware, etc. Usually, such products are manufactured and/or sold by a plurality of companies. In this specification, such a product including the plurality of products is termed “a multi-component product”.

Generally speaking, at the time users have just purchased a product, such as hardware, software, etc. of a computer, the product seller, company, or manufacturer (hereinafter, referred to as a company) registers information regarding the users, including user names, residential addresses of the users, etc. This is so-called user registration.

The users apply the company for the user registration, thereby to receives maintenance information, update information, new product information regarding and relating to the purchased product from the company.

The users apply for the user registration, in accordance with either one of the following two methods, as follow:

In the first method, the users writes information items required by the company so as to fill in a post-card-like user registration form which is attached to the purchased product.

In the second method, the users access a Web site for the user registration and provided by the company, through the Internet, and inputs the information items required by the company on the Web site.

According to the first method, when the users apply for the user registration for various kinds of hardware and software after having purchased a multi-component product such as a computer or the like, the users need to send the registration form to the company providing the product by post. According to the second method, the users need to access the Web site provided by the company. Thus, a problem arises in that the users need to go through the troublesome processes for applying for the users registration for each product included in the multi-component product. In addition, in the prior art techniques, users need to write down the required information items over and over. In such cases, the users tend to make mistakes in spelling, positions, and such.

### SUMMARY OF THE INVENTION

The present invention has been made in consideration of the above problems. It is accordingly an object of the present invention to provide a system and method for supporting user registration with ease, when information regarding a user who possesses a multi-component product including a plurality of products is registered at each company providing the products, and a recording medium which records the system and/or method.

In order to accomplish the above object, according to the first aspect of the present invention, there is provided a user registration supporting system which supports a user, who uses a multi-component product including a plurality of products provided by a plurality of companies, in applying for user registration for the plurality of products, the system comprising:

a user-information database which stores user information including a plurality of data items and regarding the user;

a user-information providing section which provides the user-information database with the user information; and

a to-be-registered information generating section which extracts at least one data item required by each of the plurality of companies for the user registration, from the user information stored in the user-information database, and generates to-be-registered information used by each of the plurality of companies for the user registration, and

wherein the system can generate the to-be-registered information for the plurality of companies at once, based on the user information.

The user registration supporting system may further comprise

a company-information database which stores specification information for specifying the at least one data item required by a plurality of companies for the user registration, and

wherein the to-be-registered information generating section generates the to-be-registered information, based on the specification information of each of the plurality of companies which is stored in the company-information database.

The user registration supporting system may further comprise

a user registration section which registers the to-be-registered information for each of the plurality of companies.

The to-be-registered information generating section may detect that new user information is stored in the user-information database, and generate to-be-registered information from the new user information.

The user information may include identification information for identifying the multi-component product used by the user;

the company-information database may store information regarding the plurality of companies providing the products according to multi-component product; and

the to-be-registered information generating section may specify the plurality of companies providing each of the products used by the user, from the information regarding the plurality of companies and stored in the company-information database, based on the identification information included in the user information, and generate the to-be-registered information according to product.

Each of the plurality of companies may be a seller or manufacturer of each of the products included in the multi-component product used by the user;

the identification information may be information regarding a model name and/or model number of the multi-component product; and

the to-be-registered information generating section may specify a seller or manufacturer for providing each of the products, from the information regarding the plurality of companies and stored in the company-information database, based on the information regarding the model name and/or model number of the multi-component product.

The user registration supporting system may comprise

a communications section which is connected, through a network, to a plurality of company terminals used respectively by the plurality of companies providing the plurality of products, and sends the to-be-registered information generated by the to-be-generated information generating section to each of the company terminals.

The communications section may be connected to a user terminal which is used by the user through a network, and receives the user information from the user terminal; and

the user-information providing section may provide the user-information database with the user information which is received by the communications section.

The user information may be correction information which is formed by correcting the user information stored in the user-information database;

the to-be-registered information generating section may extract an item which differs from an item included in the user information stored in the user-information database, from the correction information, specify a company requesting the extracted item for the user registration, based on the specification information stored in the company-information database, and newly generate to-be-registered information for the specified company.

The user information may include information regarding a product demanded by the user;

the company-information database may store information regarding a product provided by a company;

the to-be-registered information generating section may extract at least one company which can provide the product demanded by the user from the company-information database, based on the information regarding the product demanded by the user, and generate the to-be-registered information based on the specification information of the extracted company.

The system may include:

a communications section which is connected to a plurality of company terminals used by the respective companies and to the user terminal used by the user through a network, receives the user information from the user terminal, and sends the information regarding the product demanded by the user and the to-be-registered information to a company terminal used by the company extracted by the to-be-registered information generating section.

In order to achieve the above object, according to the second aspect of the present invention, there is provided a method for supporting a user, who uses a multi-component product including a plurality of products provided by a plurality of companies, in applying for user registration for the plurality of products, the method comprising:

storing user information including a plurality of data items and regarding the user;

extracting at least one data item required by each of the plurality of companies for the user registration, from the stored user information, and generating to-be-registered information used by each of the plurality of companies for the user registration, thereby to generate the to-be-registered information for the plurality of companies at once, based on the user information.

The generating may include

generating the to-be-registered information, based on specification information stored in a company-information database storing specification information for specifying at least one data item required by each of the plurality of companies for user registration.

The method may further comprise

registering the to-be-registered information for each of the plurality of companies.

The generating may include

detecting that new user information is stored in a user-information database, and generating to-be-registered information from the new user information.

The user information may include identification information for identifying the multi-component product used by the user;

the company-information database may store information regarding the plurality of companies providing the products according to multi-component product; and

the generating may include

specifying the plurality of companies providing each of the products included in the multi-component product used by the user, from the information regarding the plurality of companies and stored in the company-information database, based on the identification information included in the user information, and generating to-be-registered information according to product.

Each of the plurality of companies may be a seller or manufacturer of each of the products included in the multi-component product used by the user;

the identification information may be information regarding a model name and/or model number of the multi-component product; and

the generating may include

specifying a seller or manufacturer for providing each of the products, from the information regarding the plurality of companies and stored in the company-information database, based on the information regarding the model name and/or model number of the multi-component product.

The method may further comprise

sending the to-be-registered information which is generated by the generating to a plurality of company terminals which are used respectively by the plurality of companies providing the products, through a network.

The method may further comprise receiving the user information from a user terminal used by the user through a network.

The storing may include providing the user-information database with the user information which is received by the receiving.

The user information may be correction information which is formed by correcting the user information stored in the user-information database; and

the generating may include

extracting at least one data item which differs from a data item included in the user information stored in the user-information database, from the correction information,

specifying at least one company which requests the extracted at least one data item for user registration, based on the specification information stored in the company-information database, and

newly generating to-be-registered information for the specified at least one company.

The user information may include information regarding a product demanded by the user.

The company-information database may store information regarding a product provided by a company.

The generating may include

extracting at least one company which can provide the product demanded by the user from the company-information database, based on the information regarding the product demanded by the user, and generates the to-be-registered information based on the extracted specification information of the extracted company,

receiving user information from the user terminal used by the user through a network, and

sending the information regarding the product demanded by the user and the to-be-registered information to a company terminal used by the company extracted by the generating, through a network.

In order to achieve the above object, according to the third aspect of the present invention, there is provided a computer readable recording medium which records a program for controlling a computer to execute:

storing user information including a plurality of data items regarding a user who uses a multi-component product including a plurality of products provided by a plurality of companies; and

extracting a data item required by each of the plurality of companies for user registration, from the stored user information, and generating to-be-registered information used by each of the plurality of companies for the user registration.

### BRIEF DESCRIPTION OF THE DRAWINGS

The object and other objects and advantages of the present invention will become more apparent upon reading of the following detailed description and the accompanying drawings in which:

FIG. 1 is a diagram for explaining a user registration process adopting a user registration supporting system of the present invention;

FIG. 2 is a diagram showing the structure of a network system including a management server installed in a management company shown in FIG. 1;

FIG. 3 is a block diagram showing the structure of the management server shown in FIG. 2;

FIG. 4 is a diagram showing an example of the storage contents of a user-information database;

FIG. 5 is a diagram showing an example of the storage contents of a company-information database of the management server;

FIG. 6 is a diagram showing an example of data included in user information for a company “A”;

FIG. 7 is a diagram showing an example of data included in user information for a company “B”;

FIG. 8 is a flowchart for explaining a user registration process which is carried out by the user registration supporting system according to the first embodiment of the present invention;

FIG. 9 is a flowchart for explaining a user registration process which is carried out by the user registration supporting system according to the first embodiment;

FIG. 10 is a flowchart for explaining another process which is carried out by the user registration supporting system according to the first embodiment;

FIG. 11 is a flowchart showing a process for providing information regarding products;

FIG. 12 is a flowchart for explaining a process for updating registered information which is carried out by a user registration supporting system according to the second embodiment of the present invention;

FIG. 13 is a flowchart for explaining a process for updating registered information which is carried out by the user registration supporting system according to the second embodiment;

FIG. 14 is a diagram showing the structure of a user registration supporting system according to the third embodiment of the present invention;

FIG. 15 is a flowchart for explaining a process which is carried out by the user registration supporting system according to the third embodiment;

FIG. 16 is a flowchart for explaining a process which is carried out by the user registration supporting system according to the third embodiment; and

FIG. 17 is a diagram exemplifying data of product information.

### DETAILED DESCRIPTION OF THE PREFERRED EMBODIMENTS

Preferred embodiments of the present invention will now specifically be described with reference to the accompanying drawings.

### First Embodiment

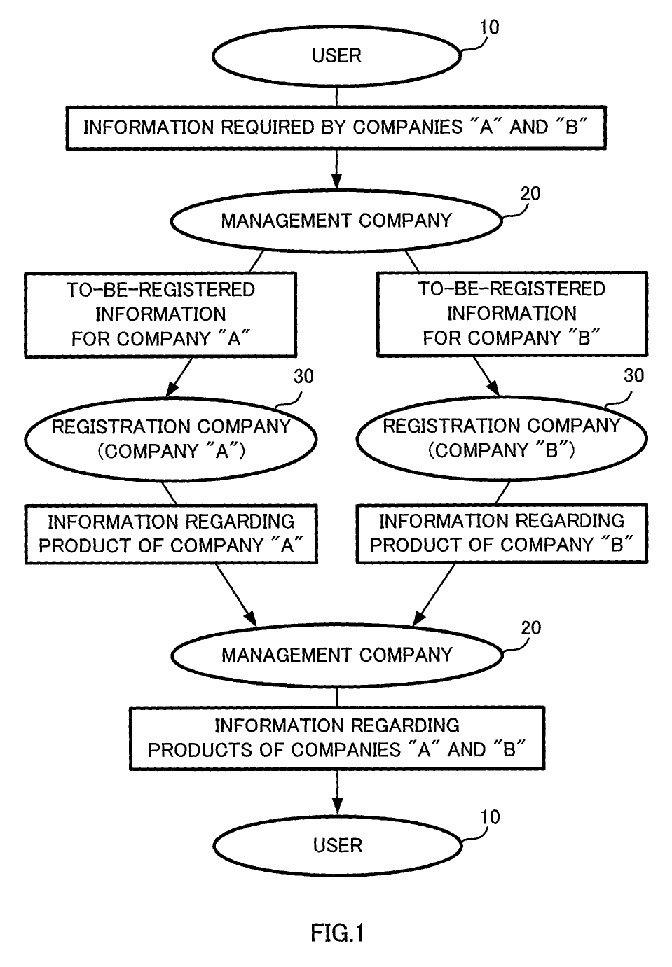

FIG. 1 shows a process which adopts a user registration supporting system of the present invention. In this process, a user can apply for a plurality of user registrations respectively corresponding to a plurality of products at once. The user registration is meant that a products' company, distributor, seller, or manufacturer (hereinafter referred to a company) registers user information including a user name, address of the user, when the user purchases the product. After the user has applied for the user registration, the user can receive various kinds of information from the company.

As shown in the illustration, the above process is carried out among a user 10, a management company 20, a plurality (two in FIG. 1) of registration companies 30.

Suppose that the user 10 uses a multi-component product. The multi-component product is, for example, a personal computer including a plurality of products, such as hardware, software, etc. which the user can apply for the user registration.

To apply for the user registration for each product included in the multi-component product, the user 10 informs the management company 20 of user information in accordance with a registration format specified by the management company 20. The registration format specified by the management company 20 consists of a set of items which covers all items (such as name, address, etc.) specified by each of the registration companies 30, and items regarding in the multi-component product.

The management company 20 manages the user information sent from the user 10. The management company 20 makes a contract with the registration companies 30 for the user registration. The management company 20 informs each of the registration companies 30 of to-be-registered information which is necessary for user registration. The to-be-registered information includes the contents of data item(s), which are necessary for the user registration performed by the registration companies 30 and which are included in the user information managed by the management company 20.

Each of the registration companies 30 is a company or manufacturer of the product included in the multi-component product which the user 10 uses. Each of the registration companies 30 makes a contract with the management company 20 for the user registration. Each of the registration companies 30 receives the to-be-registered information from the management company 20, and executes the user registration based on the retrieved to-be-registered information. Each of the registration companies 30 sends information including version-up information and maintenance information, etc. to the user 10 through the management company 20.

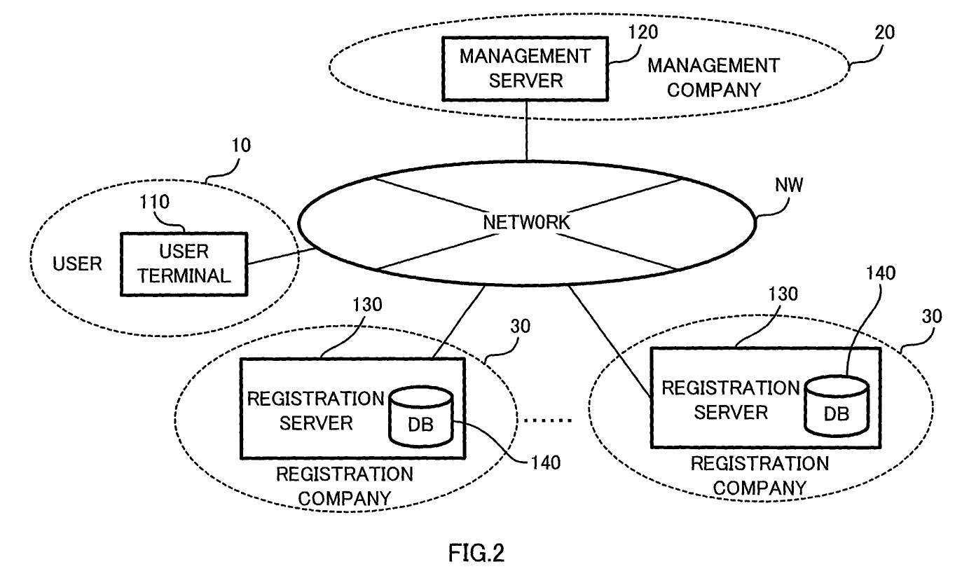

FIG. 2 is a diagram showing the structure of a network system for realizing the above process between the management company 20 and the each of the registration companies 30. As seen from FIG. 2, this network system includes a management server 120 installed in the management company 20, a registration server 130 which is connected to the management server 120 through a network NW such as the Internet, etc. and used by each of the registration companies 30, and a user terminal 110 used by the user 10.

The user terminal 110 is a multi-component product which is operable by the user 10, and has a function for accessing the network NW. The user terminal 110 is, for example, a personal computer including the hardware, software, etc. The user terminal 110 sends and receives various information to and from the management server 120 and registration server 130, through the network NW.

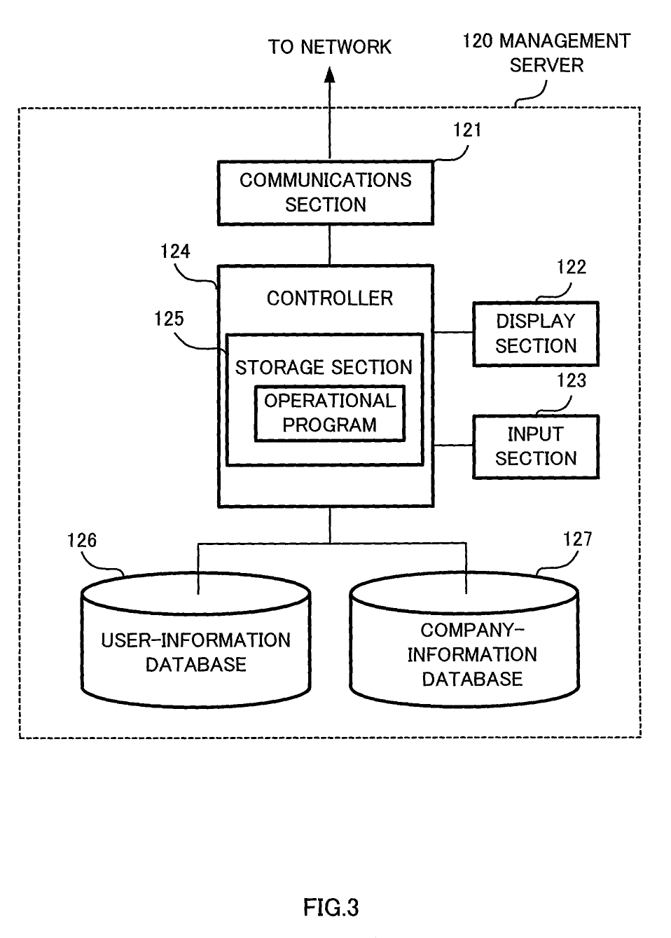

As shown in FIG. 3, the management server 120 comprises a communications section 121, a display section 122, an input section 123, and a controller 124. The communications section 121 sends and receives various information to and from the user terminal 110 and registration server 130 through the network NW. The display section 122 displays information. The input section 123 inputs various data and instructions. The controller 124 includes a storage section 125, a processor, etc., and controls the communications section 121, the display section 122, and the input section 123.

The controller 124 creates to-be-registered information, as will be explained later, and executes a process for sending the created to-be-registered information to each of the registration companies 30. The controller 124 includes a user-information database 126 and a company-information database 127, so as to execute the above process.

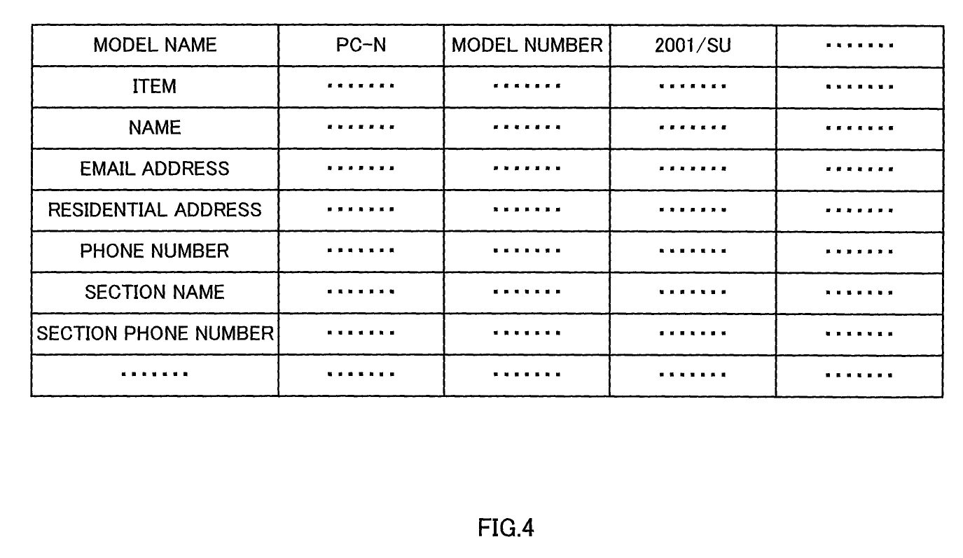

As illustrated in FIG. 4A, the user-information database 126 stores user information provided from the user terminal 110. As shown in FIG. 4A, the user information includes data items of “User Name”, “Email Address”, “Residential Address”, “Phone Number”, “Name of Workplace”, “Address of Workplace”, and “Phone Number of Workplace”.

As illustrated in FIG. 4B, the company-information database 127 stores information regarding each of the registration companies 30 for a corresponding model name and model number of the multi-component product. As shown in FIG. 4B, the information regarding each of the registration companies 30 includes data items of “Company Name”, “ID Number”, “URL”, and a set of items of the to-be-registered information. Likewise the data items stored in the user-information database 126, the to-be-registered information includes the set of data items of “User Name”, “Email Address”, “Address”, “Phone Number”, “Name of Workplace”, “Address of Workplace”, and “Phone Number of Workplace”.

The controller 124 has a function for creating the to-be-registered information, as will be explained below.

The controller 124 retrieves specification information for specifying a data item of the to-be-registered information, and stores the retrieved information in the company-information database 127.

The controller 124 sets data items of the user information, based on the data items of the to-be-registered information regarding each of the registration companies 30 and stored in the company-information database 127. Then, the controller 124 creates a user format having the set data items and other data items regarding the corresponding multi-component product. Thus created user format includes, for example, the data items of “User Name”, “Email Address”, “Address”, “Phone Number”, “Name of Workplace”, “Address of Workplace”, “Phone Number of Workplace”, “Model Name”, and “Model Number” of the corresponding multi-component product.

The controller 124 receives the user information showing the data based on the user format, and stores the retrieved user information in the user-information database 126.

The controller 124 specifies a company providing those products installed or included in the multi-component product, and extracts any corresponding item(s) from the to-be-registered information of each registration company 30, from the company-information database 127, based on the model name and model number of the multi-component product which are included in the retrieved user information.

The controller 124 extracts each data item which is included in the to-be-registered information of each corresponding registration company 30 and stored in the company-information database 127, from the user-information database 126, thereby to create to-be-registered information for each company.

The registration server 130 sends specification information for specifying each item of the to-be-registered information to the management server 120, and receives the to-be-registered information from the management server 120.

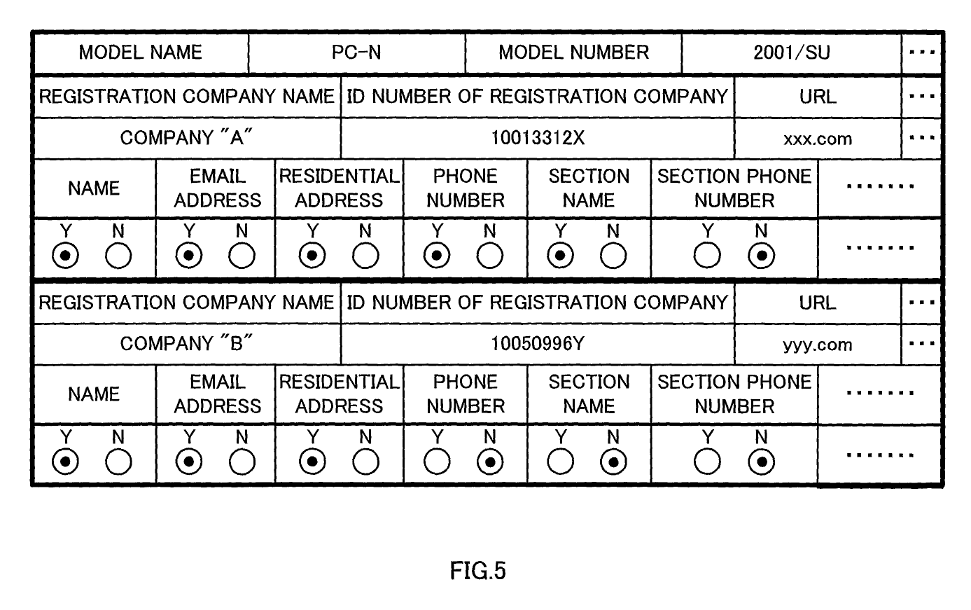

The registration server 130 has a user-registration database 140 for storing the to-be-registered information. FIG. 5A shows the structure of user-information database 140A for a company “A”, while FIG. 5B shows the structure of user-information database 140B for a company “B”. As shown in FIG. 5A, the data items required by the company “A” for the user registration include those of “User Name”, “Email Address”, “Residential Address”, “Phone Number”, and “Name of Workplace”. As shown in FIG. 5B, the data items required by the company “B” for the user registration include those of “User Name”, “Email Address”, and “Residential Address”.

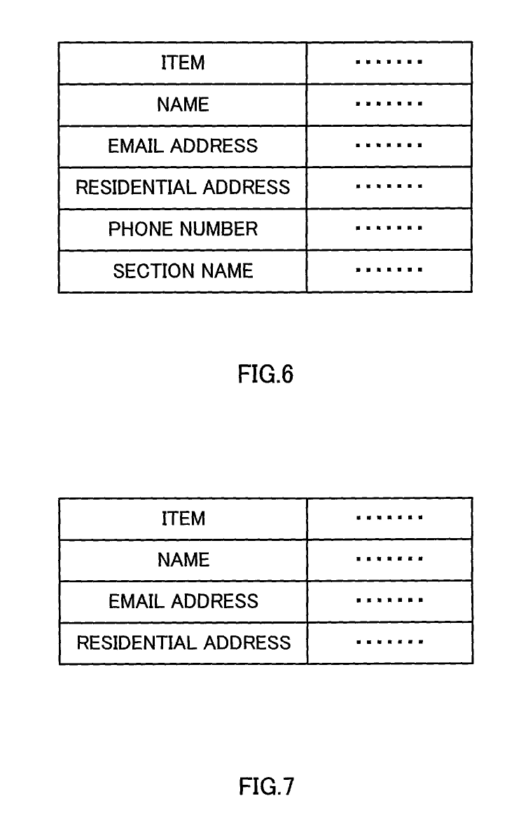

A user registration process, since the preparation of the registration until the completion thereof, in the user registration supporting system according to this embodiment, will now specifically be explained with reference to the flowcharts of FIGS. 6 to 8. Each of FIGS. 6 to 8 shows the flow of each process which is carried out among the devices included in the user registration supporting system.

In this embodiment, let it be assumed that the user 10 possesses a personal computer (the user terminal 110) storing two kinds of software to be user-registered which are installed therein. Both of the companies “A” and “B” are the registration companies 30 which provide the two kinds of software. However, in the illustration, only one registration server 30 is shown, and represents servers 130 of both companies “A” and “B”.

Before the user 10 applies for the user registration, the management company 20 obtains, in advance, the model name and model number of the user terminal 110, and also the items included in the to-be-registered information required by the companies “A” and “B” for the user registration. The flow of this preparation process for the user registration is shown in FIG. 6.

The operator of the management company 20 requests the companies “A” and “B” to inform their specification items, using the management server 120. The management server 120 sends information for instructing the registration server 130 to send the specification information, through the network NW, in accordance with the operations of the operator (Step S110).

The operator of each of the companies “A” and “B” inputs specification information for designating any corresponding item(s) of the user information, in the registration server 130, in accordance with an instruction sent from the management company 20. The registration server 130 sends the input specification information to the management server 120 through the network NW (Step S102).

The management server 120 stores the specification information received from the registration server 130 in the company-information database 127. Then, the management server 120 creates a user format based on the specification information sent respectively from the companies “A” and “B” and information for identifying the user terminal 110 (Step S103).

In the step S103, in the case where the items specified by the companies “A” and “B” are like those shown in FIGS. 4A and 4B, the management server 120 creates a user format which includes to-be-filled items of “User Name”, “Email Address”, “Residential Address”, “Phone Number”, “Name of Workplace”, “Product Name”, and “Model Number” of the user terminal 110. According to the above procedures, the preparation for the user registration is completed.

The process to be carried out, when the user 10 applies the management company 20 for the user registration, between the user terminal 110 and the management server 120 is shown in FIG. 7.

The user 10 instructs the management server 120 to send the user format, using the user terminal 110. The user terminal 110 sends information for instructing the management server 120 to send the user format, through the network NW, in accordance with the operations of the user (Step S201).

In response to the instruction, the management server 120 sends the user format to the user terminal 110 (Step S202).

The user terminal 110 receives the user format from the management server 120 through the network NW, and displays the received user format together with operational guidance therefor on a display screen (Step S203).

The user 10 inputs user information in accordance with the operational guidance displayed on the display screen of the user terminal 110, and operates the user terminal 110 so as to send the input user information to the management company 20. This user information represents data of each item included in the user format.

The user terminal 110 sends the input user information to the management server 120 through the network NW, in accordance with the operations of the user 10 (Step S204).

Following the step S204, the management server 120 receives the user information from the user terminal 110 through the network NW. After this, the management server 120 executes a process for generating to-be-registered information for each registration company 30. Upon registration of the to-be-registered information in each registration company, the management server 120 executes a process for generating registration-completion information representing the completion of registration (Step S205). The management server 120 sends the information representing the completion of registration to the user terminal 110 (Step S206). The user terminal 110 receives the sent information from the management server 120 (Step S207), and the user registration process is completed.

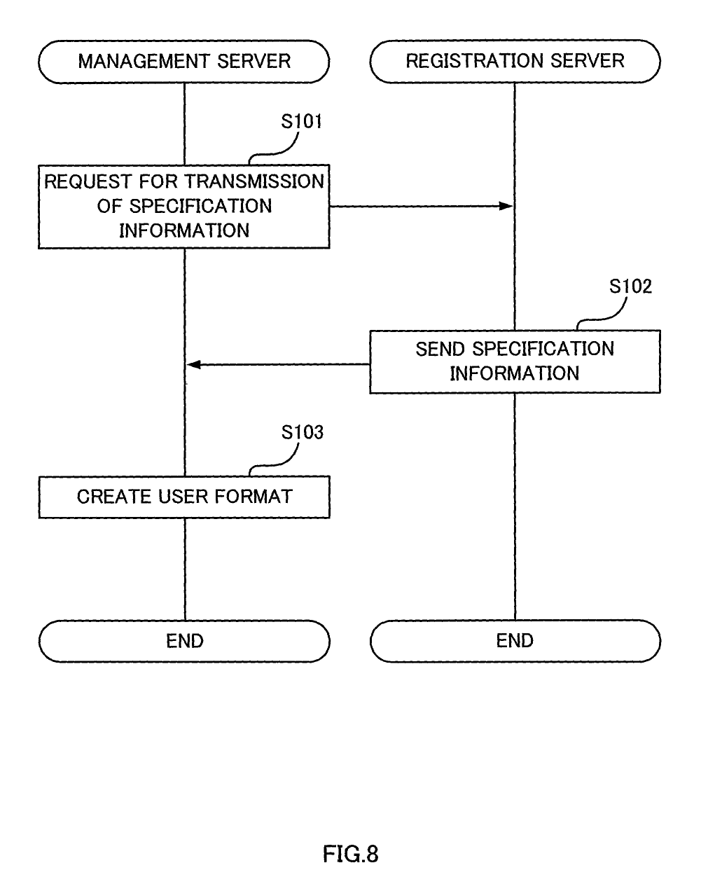

Shown in FIG. 8 are the flow of the process for generating to-be-registered information in the step S205 and the flow of the process executed by the registration server 130.

The management server 120 stores the user information in the user-information database 126 (Step S301). The company-information database 127 has the structure shown in FIG. 4B. Hence, the management server 120 extracts information representing the registration companies “A” and “B”, based on the model name (PC-N) and serial number (2001/SU) which are included in the user information (Step S302).

After this, the management server 120 extracts data regarding the specification information of each registration company, from the user information stored in the user-information database 126, and creates to-be-registered information for the company “A” and to-be-registered information for the company “B” (Step S303). Subsequently, the management server 120 sends the created to-be-registered information to the registration server 130 (Step S304).

The registration server 130 receives the to-be-registered information from the management server 120 through the network NW, and stores the received to-be-registered information in the user registration database 140 (Step S305).

In the step S305, the user registration database 140 of the company “A” registers the to-be-registered information in the manner shown in FIG. 5A, whereas the user registration database 140 of the company “B” registers the to-be-registered information like the one shown in FIG. 5B.

Following the step S305, the registration server 130 creates content information representing the registered contents stored in the user registration database 140 (Step S306).

Subsequently, the registration server 130 sends the created content information to the management server 120 through the network NW (Step S307). The management server 120 collects the content information of each of the registration companies, which are received from the registration server 130, and creates registration-completion information (Step S308).

Now, the procedure of the step S205 shown in FIG. 7 is completed.

As described above, in the user registration supporting system according to this embodiment, the user 10 needs only to inform the management company 20 of the user information including the model name and model number, etc. of the user terminal 110, thereby to achieve the user registration of the products of the respective companies “A” and “B” included in the user terminal 110 at once. When to apply for the user registration, any complicated or troublesome tasks are no longer necessary, and the applying for the user registration can be accomplished in a short time.

After the completion of the user registration, the companies “A” and “B” can provide the user 10 with the version-up information and/or maintenance information regarding their own products, for example. In this case, the management server 120 manages the user information sent from the user terminal 110, together with product information regarding each product and sent from the registration server 130.

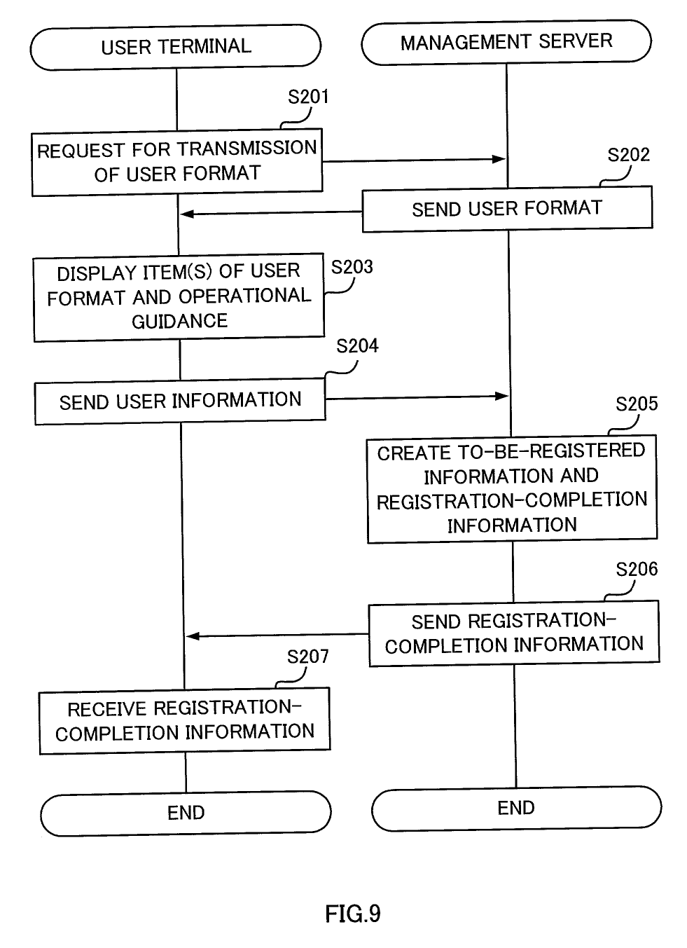

The flow of providing of product information is exemplarily shown in FIG. 9. As seen from FIG. 9, the registration server 130 sends various information such as the version-up information and the maintenance information to the management server 120 through the network NW (Step S401). Upon reception of such information from the registration server 130, the management server 120 creates product information collectively including the product information from the registration server 130, and sends the created product information to the user terminal 110 (Step S402).

The system of this embodiment supports the user not only in applying the plurality of registration companies 30 for the user registration, but also in requesting the registration companies 30 for his/her own demand. Hence, the user 10 can request the registration companies for updating the information registered thereby, or can order for any products provided by the company. Explanations will now be made to a user registration system for executing a process for updating information registered by the registration companies 30, as the second embodiment of the present invention.

### Second Embodiment

The structure of a user registration supporting system according to the second embodiment is the same as the structure of the user registration supporting system shown in FIG. 2.

The user 10 applies the management company 20 for updating of the user information.

The management company 20 updates the user information managed by the management company 20, and informs each of the registration companies 30 of the updating of the user information, based on the updated user information.

Each of the registration companies 30 has already registered to-be-registered information regarding the user 10, and updates the to-be-registered in accordance with the information from the management company 20.

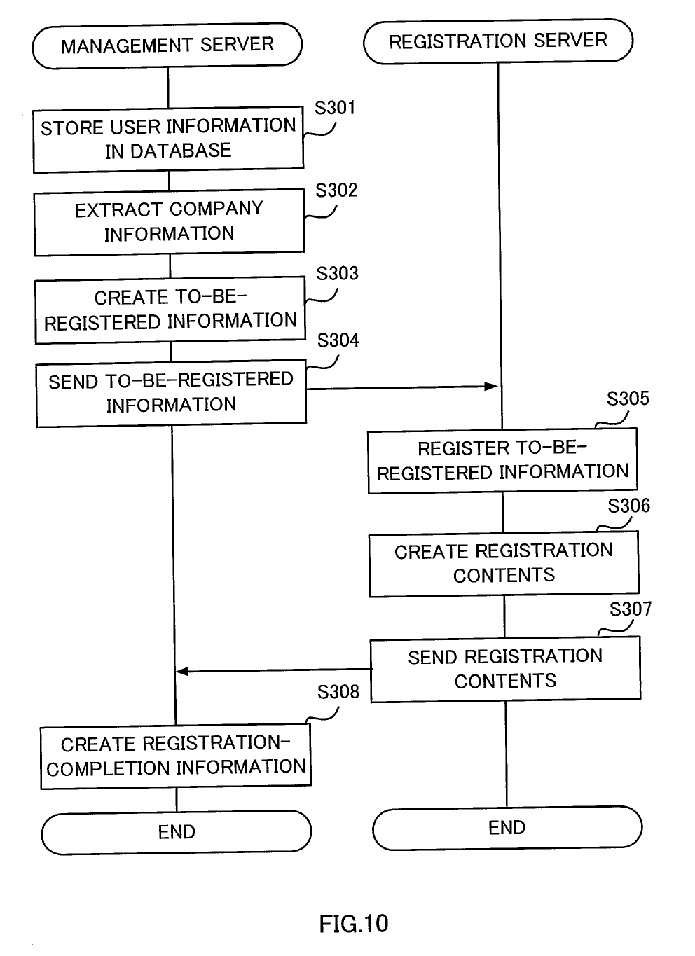

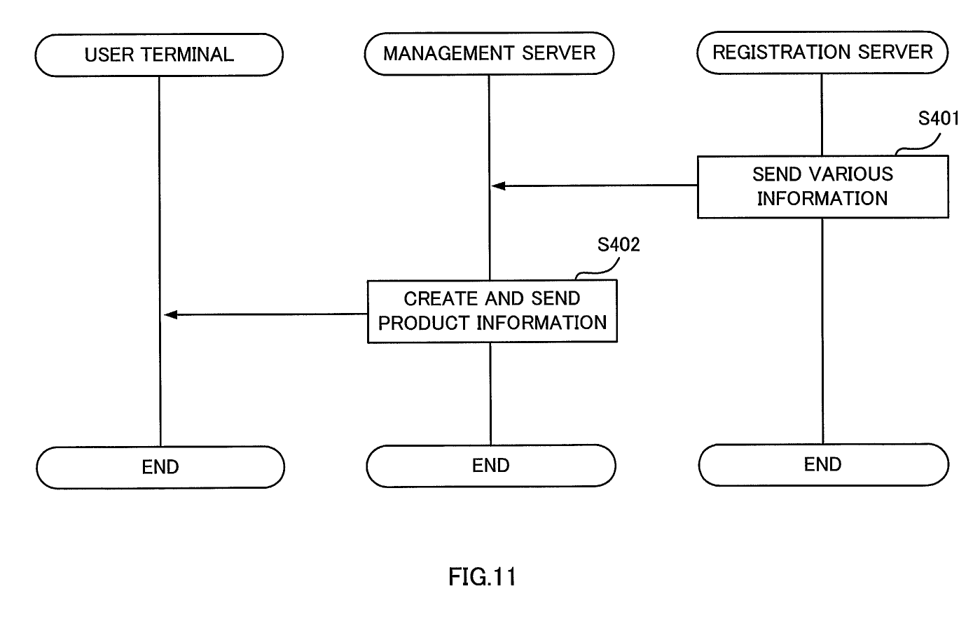

A process for updating the information registered by the user registration supporting system according to the second embodiment is shown in FIGS. 10 and 11. FIGS. 10 and 11 show the flow of the process which is carried out among the devices included in the user registration supporting system.

In this system, in the case where the user information needs to be updated by reason of the user's change of address, the user information registered by each of the registration companies 30 is updated as described below.

The user terminal 110 requests the management server 120 to transmit a updating format, through the network NW, based on operations of the user (Step S501). In response to the request, the management server 120 sends the updating format to the user terminal 110 (Step S502). The user terminal 120 receives the updating format from the management server 120 through the network NW, and displays instructions of input operations on a display screen (Step S503).

The user 10 inputs user information including the model name and number of the user terminal 110 and update data, in accordance with the instructions displayed on the display screen of the user terminal 110, and then operates the user terminal 110 to send the input user information to the management company 20. The user terminal 110 sends the input user information to the management server 120 through the network NW (Step S504). Note that the user information implies data contents which the user 10 has input in the step S504. The management server 120 receives the user information, and carries out a process for correcting registered user-information and a process for creating registration-completion information representing that the correction of the registered data contents is completed in each of the registration companies 30 (Step 505). The management server 120 sends the registration-completion information to the user terminal 110 (Step S506). The user terminal 110 receives the registration-completion information from the management server 120 through the network NW (Step S507), and the process for updating the user-registered information.

Explanations will now be made to the process for correcting registered user-information and the process for creating the registration-completion information, to be executed in the step S505.

As shown in FIG. 11, the management server 120 updates any data item(s) included in the user information stored in the user-information database 126 (Step S601). The management server 120 extracts information regarding the registration companies 30 providing products, based on the model number and the model name, from the company-information database 127 (Step S602). The management server 120 makes a list of any registration companies 30 which specify a data item(s) of the user information which is(are) to be corrected, of the extracted registration companies 30 (Step S603). Then, the management server 120 creates to-be-registered information for the registration companies 30 which are included in the list (Step S604). The management server 120 sends the created to-be-registered information to the registration companies 30 included in the list (Step S605).

The registration server 130 receives newly arrival to-be-registered information, and updates the data contents of the user-registration database 140 based on the received information (Step S606). The registration server 130 reads the updated to-be-registered information from the user-registration database 140, and creates content information regarding registered contents (Step S607). The registration server 130 sends the created content information to the management server 120 through the network NW (Step S608). The management server 120 gathers the content information received from each of the registration servers 130, so as to create the registration-completion information (Step S609).

As explained above, in this embodiment, in the case where, for example, the user information such as the user address, etc. should be updated, the user 10 needs only to inform the management company 20 about the necessity of the updating. Then, the information to be updated is sent to each company which provides the products included in the multi-component product. Hence, any complicated or troublesome tasks are no longer necessary for the updating of the registered contents, thus the user 10 can accomplish the updating of the registered information with ease and in a short time.

### Third Embodiment

A user registration supporting system according to the third embodiment of the present invention performs the user registration and the updating of the registered user-information, and supports the user in shopping processes.

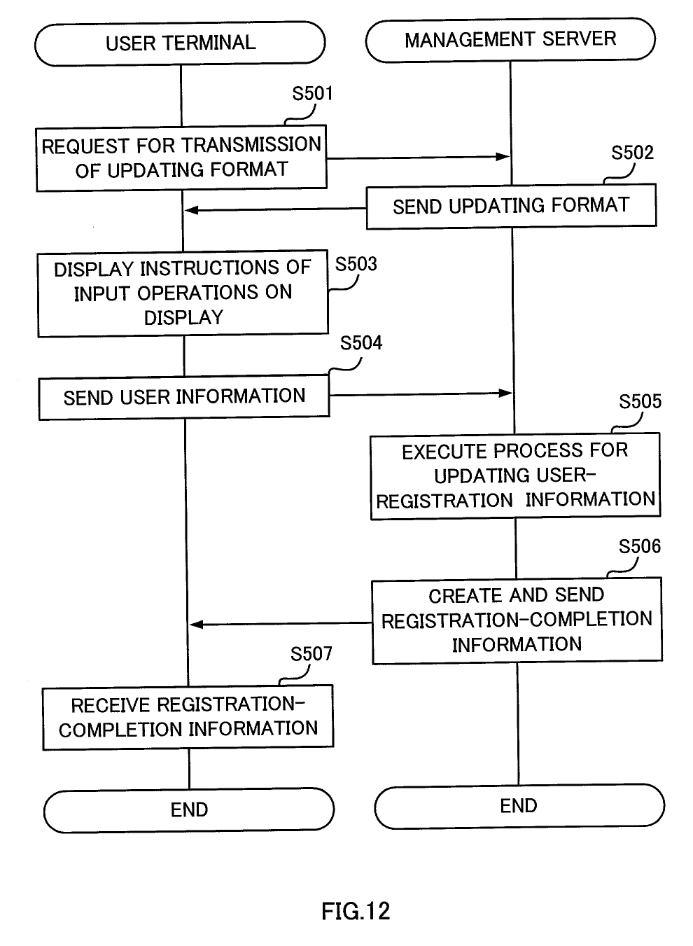

FIG. 12 is a diagram showing the structure of the user registration supporting system of this embodiment. This user registration supporting system comprises the user terminal 110, the management server 120, the registration server 130, a new-company terminal 150, and the network NW. The component elements, except the new-company terminal 150, are the same as those in the user registration supporting system shown in FIG. 2. Hence, the same reference numerals denote the same component elements.

The user 10 is registered at the management company 20 and each of the registration companies 130.

The management company 20 is under contract also to a new company 50. The new company 50 is a company other than the registration companies 30, has nothing to do with the products which are registered under the name of the user 10. The new company 50 specifies data items for user information necessary for the user registration, receives to-be-registered information based on the specified items, and provides the user 10 with a product.

The management server 120 stores also information regarding the new company 50 in the company-information database 127. The new-company terminal 150 is installed in each new company, has basically the same function as the registration server 130, and includes a data processing device and a database, etc. Stored in the database of the new-company terminal 150 is advertisement information, etc. regarding products which are provided by the new-company. The new-company terminal 150 sends and receives to-be-registered information, etc. to and from the management server 120. The new-company terminal 150 sends information regarding the products to be provided by the new company, to the user terminal 110.

Explanations will now be made to processes executed by the user registration supporting system of this embodiment, with concrete examples thereof.

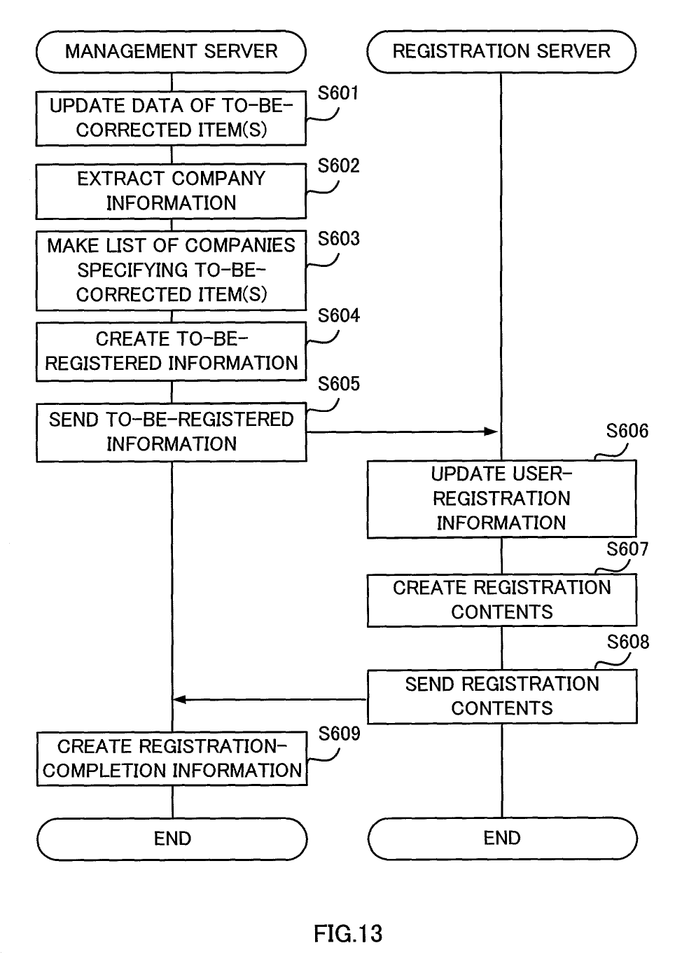

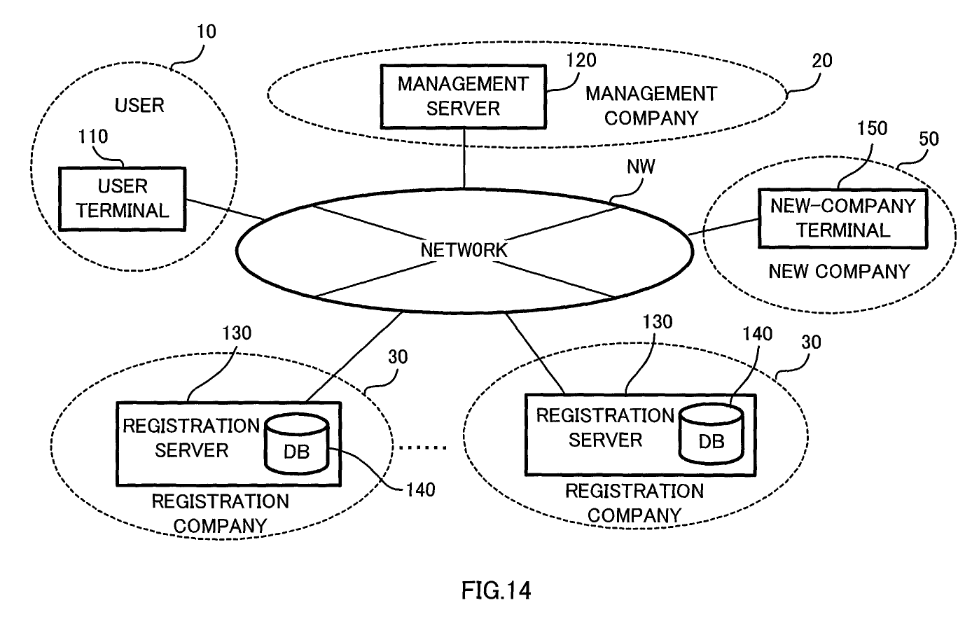

Shown in FIGS. 13 and 14 are processes which are carried out when the user 10 is moving to a new address and desires to make a contract with an Internet provider providing the most reasonable services to the user in a region of the new address.

The management server 120 retrieves information for specifying data items included in the user information from the new-company terminal 150, and stores the retrieved information in the company-information database 127.

Explanations will now be made to a process for informing the new company 50 about a request sent from the user 10.

The user 10 inputs update data including the date on which the user 10 moves to the new address, the new address, and the like, through the user terminal 110. The user 10 inputs also requesting data representing a request for searching the Internet provider providing the most reasonable services to the user 10 in the new residential region. As shown in FIG. 13, the user terminal 110 sends the input update data and requesting data to the management server 120 through the network NW (Step S701). The management server 120 receives the sent update data and requesting data, and stores the received data in the user-information database 126 (Step S702). The management server 120 sends the update data to the registration companies 30 based on the model name and number of the user terminal 110 (Step S703), and supports each of the registration companies 30 in updating the registered user information. The management server 120 makes a list of new companies 50 from the company-information database 127, based on the requesting data (Step S704). The management server 120 creates to-be-registered information for each of the new companies 50, based on the specification information specified by each of the new companies 50 which are included in the list (Step S705). The management server 120 sends the created to-be-registered information and the requesting data to the new-company terminal 150 included in each of the listed new companies 50. Further, the management server 120 sends the data contents and the name of each of the new companies 50, which have been sent to the new-company terminal 150, to the user terminal 110 (Step S706). Hence, the user 10 can be aware that his/her own information is sent to which companies. The new-company terminal 150 receives the to-be-registered information and requesting data, and carries out a process for supporting the user selecting and purchasing a product based on the requesting data, as will be explained later (Step S707).

The process executed in the step S707 is exemplarily shown in FIG. 14.

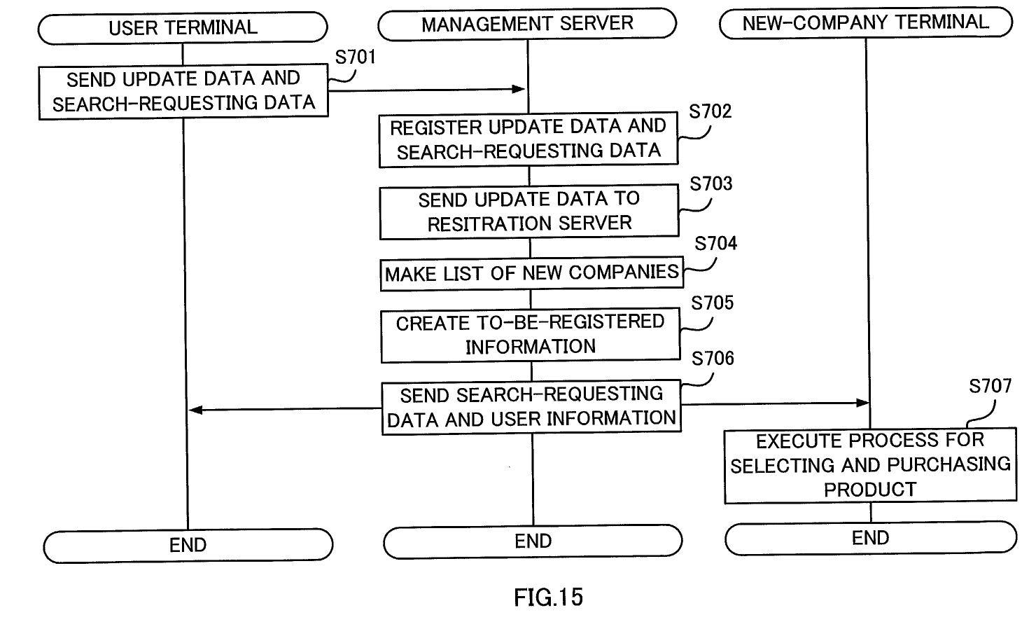

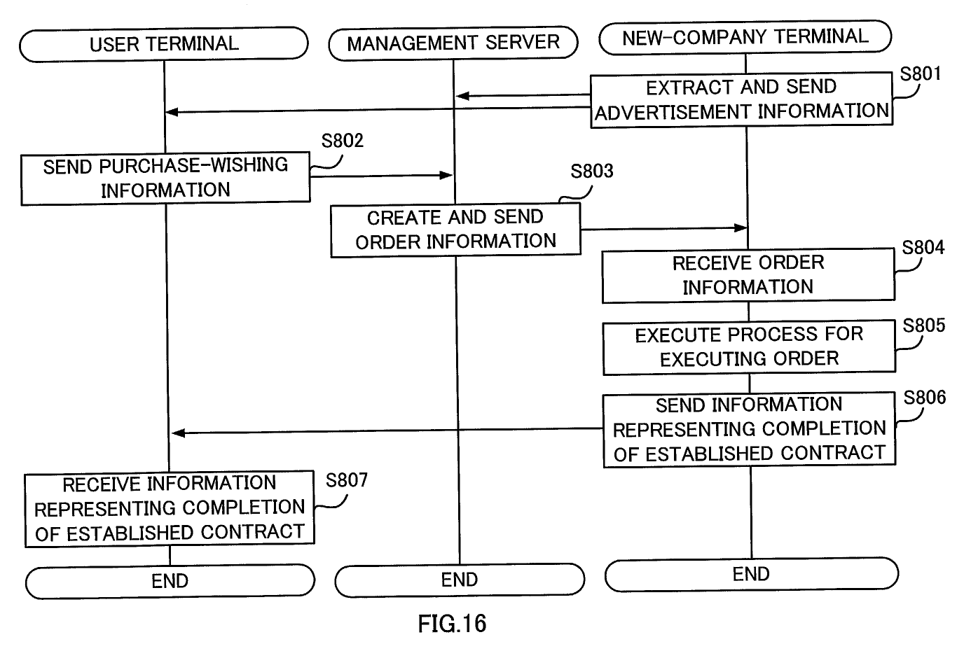

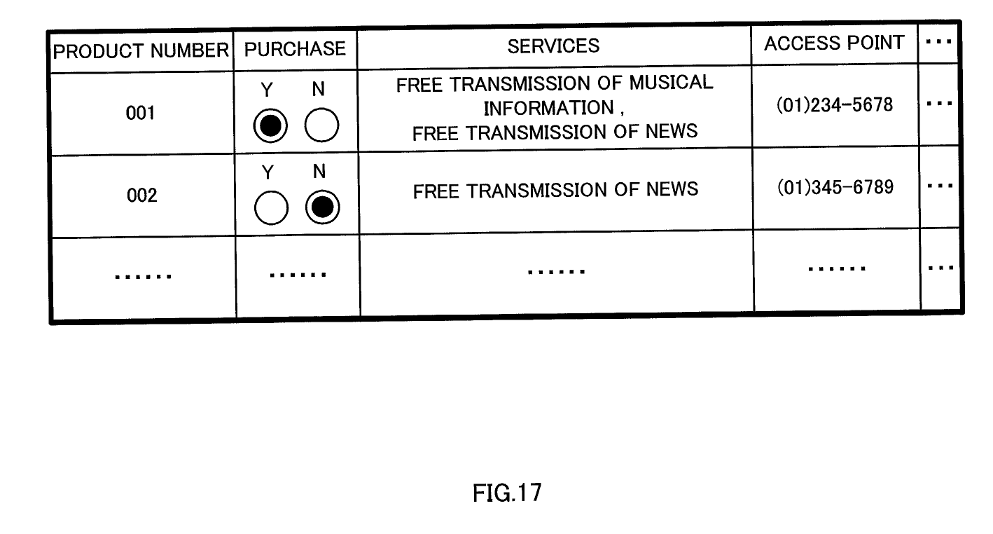

The new-company terminal 150 extracts advertisement information for products from an internal database, and sends the extracted advertisement information to the user terminal 110 and management server 120 (Step S801). The data of the advertisement information includes, as shown in FIG. 15, service contents, an access point (telephone number to be accessed).

The user 10 determines whether to purchase any of the products included in the advertisement information retrieved by the user terminal 110. When determined to purchase a product, the user 10 operates the user terminal 110, so as to purchase the product. The user terminal 110 sends purchase-wishing information to the management server 120 (Step S802). The management server 120 receives the purchase-wishing information from the user terminal 110, creates order information regarding procedures for purchasing the product, based on the received purchase-wishing information, and sends the crated order information to the new-company terminal 150 (Step S803).

The new-company terminal 150 receives the order information from the management server 120 (Step S804). Based on the order information, the new-company terminal 150 carries out a process for executing the order (Step S805). The new-company terminal 150 sends information representing completion of a contract made between the user 10 and the new company 50 for a product (in this case, Internet providing services) (Step S806). The user terminal 110 then receives the information representing the completion of a contract from the new-company terminal 150 (Step S807), so that the user can receive the desired product (the Internet services). In the step S803, the management server 120 may have the structure for sending search-requesting data to the registration server 130 in addition to the new-company terminal 150.

The explanations have been made to an example, wherein the product which the user 10 desires to purchase is the Internet services. However, the product may be software, hardware, etc. In the case where the desired product is software, the desired product may be sent from the new-company terminal 150 to the user terminal 110 through the network, subsequently after the step S806. In the case where the desired product is hardware, the new company 50 sends the desired product to the user 10 by mail, subsequently after the step S806.

According to the user registration supporting system of this third embodiment, the user 10 having purchased the multi-component product can purchase products from the new company 50, other than the registration companies 30 which support the products. Hence, the user 10 can select the desired product.

The new company 50 has nothing to do with the multi-component product. However, the new company 50 can collect the user information, thus enabling to get a new business opportunity.

As explained above, according to the present invention, the user 10 can not only apply for the user registration and update the registered user information, but also receive various services for searching for desired information and for shopping a desired product.

Such services are those to be provided to the user registered at the management company, etc. Thus, both the user 10 and each of the companies can choose a trustful business partner (company).

The present invention is not limited to the above embodiments, and various modifications and changes can be made. In the above-described embodiments, the user terminal 110 has been described as one should be registered. If the product which should be user-registered does not have a function for connecting to the network NW, the user 10 may register the user of the purchased product, using any other electronic device having the function for connecting to the network NW, such as a personal computer, or the like. In this case, the user 10 accesses a Web site of the management company 20 through the network NW, using the personal computer, for example, and carries out the procedures for registering the to-be-registered product.

Various embodiments and changes may be made thereonto without departing from the broad spirit and scope of the invention. The above-described embodiments are intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

This application is based on Japanese Patent Application No. 2000-120476 filed on Apr. 21, 2000, and including specification, claims, drawings and summary. The disclosure of the above Japanese Patent Application is incorporated herein by reference in its entirety.

What is claimed is:

1. A user registration supporting system which supports a user, who uses a multi-component product including a plurality of products provided by a plurality of companies, in applying for user registration for the plurality of products, said system comprising:
a user-information database which stores user information including a plurality of data items and regarding the user;
a user-information providing section which provides said user-information database with the user information; and
a to-be-registered information generating section which extracts at least one data item required by each of the plurality of companies for the user registration, from the user information stored in said user-information database, and generates to-be-registered information used by each of the plurality of companies for the user registration, and
wherein said system can generate the to-be-registered information for the plurality of companies at once, based on the user information.

2. The user registration supporting system according to claim 1, further comprising
a company-information database which stores specification information for specifying the at least one data item required by a plurality of companies for the user registration, and
wherein said to-be-registered information generating section generates the to-be-registered information, based on the specification information of each of the plurality of companies which is stored in said company-information database.

3. The user registration supporting system according to claim 2, wherein further comprising
a user registration section which registers the to-be-registered information for each of the plurality of companies.

4. The user registration supporting system according to claim 2, wherein said to-be-registered information generating section detects that new user information is stored in said user-information database, and generates to-be-registered information from the new user information.

5. The user registration supporting system according to claim 4, wherein:
said user information includes identification information for identifying the multi-component product used by the user;
said company-information database stores information regarding the plurality of companies providing the products according to multi-component product; and
said to-be-registered information generating section specifies the plurality of companies providing each of the products used by the user, from the information regarding the plurality of companies and stored in said company-information database, based on the identification information included in the user information, and generates the to-be-registered information according to product.

6. The user registration supporting system according to claim 5, wherein:
each of said plurality of companies is a seller or manufacturer of each of the products included in the multi-component product used by the user;
the identification information is information regarding a model name and/or model number of the multi-component product; and
said to-be-registered information generating section specifies a seller or manufacturer for providing each of the products, from the information regarding the plurality of companies and stored in said company-information database, based on the information regarding the model name and/or model number of the multi-component product.

7. The user registration supporting system according to claim 5, comprising
a communications section which is connected, through a network, to a plurality of company terminals used respectively by the plurality of companies providing the plurality of products, and sends the to-be-registered information generated by said to-be-generated information generating section to each of the company terminals.

8. The user registration supporting system according to claim 7, wherein:
said communications section is connected to a user terminal which is used by the user through a network, and receives the user information from the user terminal; and
said user-information providing section provides said user-information database with the user information which is received by said communications section.

9. The user registration supporting system according to claim 2, wherein:
the user information is correction information which is formed by correcting the user information stored in said user-information database;
said to-be-registered information generating section extracts an item which differs from an item included in the user information stored in the user-information database, from the correction information, specifies a company requesting the extracted item for the user registration, based on the specification information stored in said company-information database, and newly generates to-be-registered information for the specified company.

10. The user registration supporting system according to claim 2, wherein:
the user information includes information regarding a product demanded by the user;
said company-information database stores information regarding a product provided by a company;
said to-be-registered information generating section extracts at least one company which can provide the product demanded by the user from said company-information database, based on the information regarding the product demanded by the user, and generates the to-be-registered information based on the specification information of the extracted company, and wherein said system includes
a communications section which is connected to a plurality of company terminals used by the respective companies and to the user terminal used by the user through a network, receives the user information from the user terminal, and sends the information regarding the product demanded by the user and the to-be-registered information to a company terminal used by the company extracted by said to-be-registered information generating section.

11. A method for supporting a user, who uses a multi-component product including a plurality of products provided by a plurality of companies, in applying for user registration for the plurality of products, said method comprising:
storing user information including a plurality of data items and regarding the user;
extracting at least one data item required by each of the plurality of companies for the user registration, from the stored user information, and generating to-be-registered information used by each of the plurality of companies for the user registration, thereby to generate the to-be-registered information for the plurality of companies at once, based on the user information.

12. The method according to claim 11, wherein said generating includes
generating the to-be-registered information, based on specification information stored in a company-information database storing specification information for specifying at least one data item required by each of the plurality of companies for user registration.

13. The method according to claim 12, further comprising
registering the to-be-registered information for each of the plurality of companies.

14. The method according to claim 12, wherein said generating includes
detecting that new user information is stored in a user-information database, and generating to-be-registered information from the new user information.

15. The method according to claim 14, wherein:
said user information includes identification information for identifying the multi-component product used by the user;
the company-information database stores information regarding the plurality of companies providing the products according to multi-component product; and
said generating includes
specifying the plurality of companies providing each of the products included in the multi-component product used by the user, from the information regarding the plurality of companies and stored in the company-information database, based on the identification information included in the user information, and generating to-be-registered information according to product.

16. The method according to claim 15, wherein:
each of the plurality of companies is a seller or manufacturer of each of the products included in the multi-component product used by the user;
the identification information is information regarding a model name and/or model number of the multi-component product; and
said generating includes
specifying a seller or manufacturer for providing each of the products, from the information regarding the plurality of companies and stored in the company-information database, based on the information regarding the model name and/or model number of the multi-component product.

17. The method according to claim 15, further comprising
sending the to-be-registered information which is generated by said generating to a plurality of company terminals which are used respectively by the plurality of companies providing the products, through a network.

18. The method according to claim 17, further comprising receiving the user information from a user terminal used by the user through a network, and
wherein said storing includes providing the user-information database with the user information which is received by said receiving.

19. The method according to claim 12, wherein:
the user information is correction information which is formed by correcting the user information stored in the user-information database; and
said generating includes
extracting at least one data item which differs from a data item included in the user information stored in the user-information database, from the correction information,
specifying at least one company which requests the extracted at least one data item for user registration, based on the specification information stored in the company-information database, and
newly generating to-be-registered information for the specified at least one company.

20. The method according to claim 12, wherein:
the user information includes information regarding a product demanded by the user;
the company-information database stores information regarding a product provided by a company; and
said generating includes
extracting at least one company which can provide the product demanded by the user from the company-information database, based on the information regarding the product demanded by the user, and generates the to-be-registered information based on the extracted specification information of the extracted company,
receiving user information from the user terminal used by the user through a network, and
sending the information regarding the product demanded by the user and the to-be-registered information to a company terminal used by the company extracted by said generating, through a network.

21. A computer readable recording medium which records a program for controlling a computer to execute:
storing user information including a plurality of data items regarding a user who uses a multi-component product including a plurality of products provided by a plurality of companies; and
extracting a data item required by each of the plurality of companies for user registration, from the stored user information, and generating to-be-registered information used by each of the plurality of companies for the user registration.
